(19) United States
(12) Patent Application Publication
(10) Pub. No.: US 2026/0244373 A1
(43) Pub. Date: Aug. 20, 2026

(54) NON-TRANSITORY COMPUTER-READABLE STORAGE MEDIUM STORING PRINT CONTROL PROGRAM, INFORMATION PROCESSING APPARATUS, AND NOTIFICATION METHOD

(71) Applicant: SEIKO EPSON CORPORATION, TOKYO (JP)

(72) Inventor: Ryosuke NASUNO, NAGANO-SHI (JP)

(21) Appl. No.: 19/545,048

(22) Filed: Feb. 20, 2026

(30) Foreign Application Priority Data
Feb. 20, 2025 (JP) 2025-025684

(51) Int. Cl. G06F 3/12

(52) U.S. Cl. CPC G06F 3/121; G06F 3/1207; G06F 3/1228; G06F 3/1235; G06F 3/1259

(57) ABSTRACT

A non-transitory computer-readable storage medium stores a print control program that causes a computer to function as an information acquiring section that acquires both first information and second information relating to printing by a printer, and a notification instructing section that causes an OS to perform a notification based on the first information and the second information. The first information is obtainable by not only a general-purpose printer driver but also the information acquiring section. The second information is not obtainable by the general-purpose printer driver but is obtainable by the information acquiring section.

The present application is based on, and claims priority from JP Application Serial Number 2025-025684, filed February 20, 2025, the disclosure of which is hereby incorporated by reference herein in its entirety.

### BACKGROUND

### Technical Field

The present disclosure relates to a non-transitory computer-readable storage medium storing a print control program, an information processing apparatus, and a notification method.

### Related Art

In JP-A-2021-22166, communication with a printer in accordance with an OS-standard protocol is described.

An OS-standard printer driver cannot acquire information about functions unique to a vendor or a model of a printer other than information about standard functions of the printer. Therefore, an improvement has been desired.

### SUMMARY

According to an aspect of the present disclosure, a non-transitory computer-readable storage medium stores a print control program that causes a computer to function as an information acquiring section that acquires both first information and second information relating to printing by a printer and a notification instructing section that causes an OS to perform a notification based on the first information and the second information. The first information is obtainable by not only a general-purpose printer driver but also the information acquiring section. The second information is not obtainable by the general-purpose printer driver but is obtainable by the information acquiring section.

According to another aspect of the present disclosure, an information processing apparatus includes an information acquiring section that acquires both first information and second information relating to printing by a printer and a notification instructing section that causes an OS to perform a notification based on the first information and the second information. The first information is obtainable by not only a general-purpose printer driver but also the information acquiring section. The second information is not obtainable by the general-purpose printer driver but is obtainable by the information acquiring section.

According to a further aspect of the present disclosure, a notification method includes acquiring, by an information acquiring section, both first information and second information relating to printing by a printer and causing, by a notification instructing section, an OS to perform a notification based on the first information and the second information. The first information is obtainable by not only a general-purpose printer driver but also the information acquiring section. The second information is not obtainable by the general-purpose printer driver but is obtainable by the information acquiring section.

### BRIEF DESCRIPTION OF THE DRAWINGS

FIG. 1 is a block diagram illustrating a configuration of an information processing apparatus.

FIG. 2 is a flowchart illustrating a state monitoring process after transmission of print data.

FIG. 3 is a view illustrating a display example of a toast notification indicating occurrence of an error.

FIG. 4 is a view illustrating a display example of a detail screen.

FIG. 5 is a flowchart illustrating a print progress monitoring process.

FIG. 6 is a view illustrating a display example of a toast notification indicating progress of printing.

FIG. 7 is a flowchart illustrating a state monitoring process during operation of an auxiliary app.

### DESCRIPTION OF EMBODIMENTS

Here, embodiments of the present disclosure will be described in the following order.

### 1. First Embodiment

1-1. Overall Configuration

1-1-1. Configuration of Printer

1-1-2. Configuration of Information Processing Apparatus

1-2. State Monitoring Process after Print Data Transmission

### 2. Second Embodiment

2-1. Progress Monitoring Process of Printing

### 3. Other Embodiments

### 1. First Embodiment

1-1. Overall Configuration

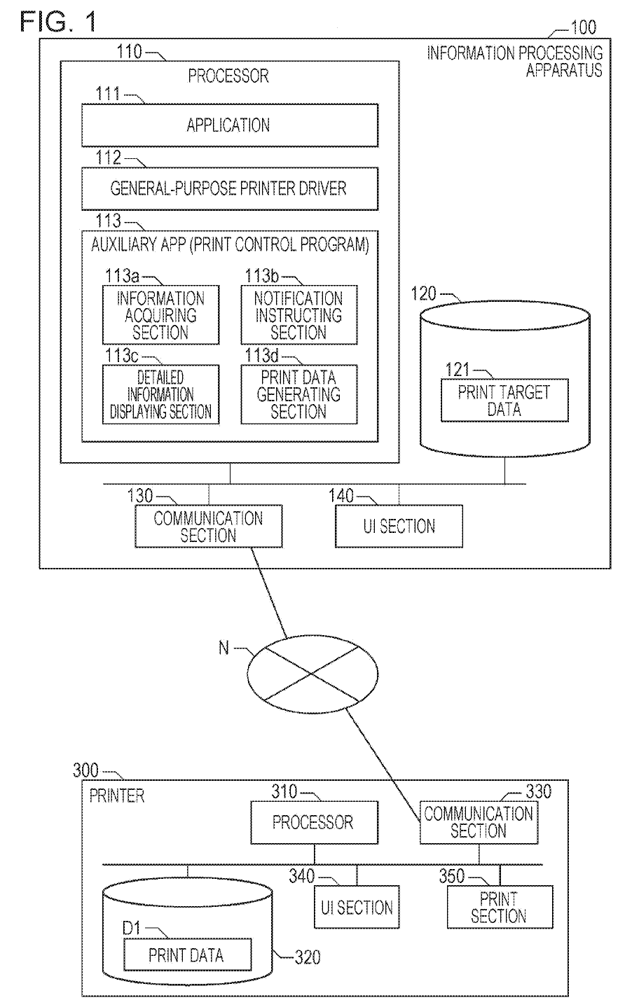

FIG. 1 is a diagram illustrating an overall configuration including an information processing apparatus 100 according to an embodiment of the present disclosure. In this embodiment, the information processing apparatus 100 is a personal computer (PC), and is an apparatus used by a user who requests printing. The information processing apparatus 100 can communicate with a printer 300 via a network N, such as a local area network (LAN) or the Internet. When the user operates the information processing apparatus 100 to request the printer 300 to perform printing of print target data 121, print data D1 obtained by converting the print target data 121 into a format suitable for printing by the printer 300 is transmitted from the information processing apparatus 100 to the printer 300. The printer 300 performs printing based on the print data D1.

### 1-1-1. Configuration of Printer

The printer 300 includes a processor 310, a storage medium 320, a communication section 330, a UI section 340, and a print section 350. The processor 310 includes a central processing unit (CPU), a read-only memory (ROM), and a random access memory (RAM) (not illustrated), and controls the individual sections of the printer 300 by executing a control program stored in the storage medium 320. Note that the processor 310 may be configured by a single chip, may be configured by a plurality of chips, or may be configured as a system-on-a-chip (SoC) together with various functional blocks for operating the printer 300. Furthermore, an application specific integrated circuit (ASIC) may be employed instead of the CPU, or the CPU and the ASIC may cooperate with each other. When each of the apparatuses according to this embodiment includes a processor, the processor can be realized in various forms, similarly to the processor 310.

The storage medium 320 stores various programs to be executed by the processor 310 and control data. Furthermore, the print data D1 transmitted from the information processing apparatus 100 is stored. The communication section 330 includes a circuit used for communication with other apparatuses in accordance with various wired or wireless communication protocols. In this embodiment, the printer 300 can communicate with the information processing apparatus 100 via the communication section 330. The UI section 340 includes a touch panel display and keys for displaying various types of information to a user and inputting a user operation.

The print section 350 includes an actuator, a driving component, a mechanical component, and various sensors for detecting a state of the printer 300, which are used to perform printing by ejecting ink onto a printing medium. Examples of the sensors include a sensor which detects the number of remaining printing media, a sensor which detects a jam in a transport path of a printing medium, a sensor which detects an amount of remaining ink for each ink color, and sensors which detect opening/closing states of individual covers provided in the individual sections. In this embodiment, a plurality of sensors for detecting a jam of a printing medium are provided in the transport path, and the processor 310 can determine a position where the printing medium is jammed based on output signals of the sensors.

When receiving the print data D1 from the information processing apparatus 100 via the communication section 330, the processor 310 controls the print section 350 based on the print data D1 so as to execute printing. In this embodiment, it is assumed that the print section 350 performs printing by an ink jet method, but the printing method is not limited thereto.

In addition, the processor 310 can transmit information indicating a state of a print job being executed or information indicating a state of the printer 300 to the information processing apparatus 100 via the communication section 330 in response to an inquiry from the information processing apparatus 100. The information indicating a state of a print job includes information indicating whether printing of the print job requested from the information processing apparatus 100 to the printer 300 has been completed up to a final page. The information indicating a state of a print job includes information about a name of a file requested to be printed, the number of pages, and the like.

The information indicating a state of the printer 300 can be detected by the various sensors included in the printer 300, and more specifically, for example, includes information about a fact that a printing medium is used up, a fact that the ink is used up, a fact that a printing medium is jammed, a position at which the printing medium is jammed, a fact that one of the covers is in an open state, and identification information of the opened cover.

### 1-1-2. Configuration of Information Processing Apparatus

The information processing apparatus 100 is a computer including a processor 110, a storage medium 120, a communication section 130, and a UI section 140. The processor 110 can execute an operating system (OS) stored in the storage medium 120, programs, such as a general-purpose printer driver 112 and an auxiliary application (app) 113, and various application programs including an application 111.

The storage medium 120 is a storage device, such as a hard disk drive, a solid state drive, or another memory. The storage medium 120 stores various programs including the OS, the general-purpose printer driver 112, the auxiliary app 113, and the application 111. The storage medium 120 further stores various files that can be displayed or edited by the application 111 or the like. The various files may be the print target data 121.

The communication section 130 includes a communication interface that performs communication with other devices in accordance with various wired or wireless protocols. In this embodiment, the information processing apparatus 100 can communicate with the printer 300 via the communication section 130.

The UI section 140 includes a display and keys. Furthermore, a device, such as a mouse, may be connected via the communication section 130. Moreover, the display may be a touch panel display. The processor 110 displays various types of information on the display, and receives an operation performed using an input section, such as a key, a mouse, or a touch panel.

The general-purpose printer driver 112 is an OS-standard printer driver provided by a vendor that provides the OS. For example, the general-purpose printer driver 112 is a Windows® OS-standard printer driver. The general-purpose printer driver 112 is a program capable of causing various types of printers to execute printing.

The auxiliary app 113 as a print control program is an application program for assisting the general-purpose printer driver 112 and causing the processor 110 to execute print control suitable for the capabilities of a target printer and print control for realizing functions unique to a vendor of the printer. The auxiliary app 113 is provided by the vendor of the printer or the like. The auxiliary app 113 is also referred to as a Print Support Application (PSA).

The processor 110 functions as an information acquiring section 113a, a notification instructing section 113b, and a detailed information displaying section 113c by executing the auxiliary app 113. A print data generating section 113d will be described in a second embodiment.

By the function of the information acquiring section 113a, the processor 110 acquires both the first information and the second information relating to the printing in the printer 300. The first information is obtainable by the general-purpose printer driver 112 but is also obtainable by the information acquiring section 113a. The second information is not obtainable by the general-purpose printer driver 112 but is obtainable by the information acquiring section 113a. For example, the first information indicates a state of the printer in a common form that does not depend on a vendor or a model, and the second information indicates details of a state of the printer in a form that depends on a vendor or a model.

Specifically, for example, the processor 110 can acquire information indicating that the printing medium is jammed as the first information by the general-purpose printer driver 112. The processor 110 can also acquire the information indicating that the printing medium is jammed by executing the auxiliary app 113. The processor 110 cannot acquire more detailed information indicating a position where the printing medium is jammed by the general-purpose printer driver 112, but can acquire the information by executing the auxiliary app 113. For example, the information indicating a specific portion where the printing medium is jammed corresponds to the second information. A form (for example, an error number or an error code) of information indicating such a detailed state may vary depending on a vendor or a model.

In addition, for example, since the processor 110 cannot acquire a state of hardware related to a function other than a function determined in advance as a standard function of the printer using the general-purpose printer driver 112, information indicating such a state of hardware corresponds to the second information.

Using the function of the notification instructing section 113b, the processor 110 causes the OS to perform a notification based on the first information and the second information. That is, the processor 110 performs the notification based on the first information and the second information by using a notification function of the OS. In this embodiment, the processor 110 uses a toast notification as such a notification. The toast notification pops up and is displayed at an edge of a display screen of the UI section 140 of the information processing apparatus 100.

When the first information is acquired from the printer 300 by a process performed by the general-purpose printer driver 112 and the second information is acquired from the printer 300 by a process performed by the auxiliary app 113, a state of the printer 300 is acquired in two steps. For this reason, for example, a state of the printer 300 at a timing when the second information is acquired may be changed from a state of the printer 300 at a timing when the first information is acquired, and there is a possibility that consistency is not maintained. According to the information processing apparatus 100 of this embodiment, since the processor 110 acquires both the first information and the second information by the information acquiring section 113a of the auxiliary app 113, it is possible to reduce the possibility that such a situation occurs.

When information indicating an error that has occurred in the printer 300 is included in the first information or the second information, the processor 110 performs a toast notification indicating the occurrence of the error by the function of the notification instructing section 113b. With this configuration, when the processor 110 detects that an error has occurred in the printer 300 based on the information acquired from the printer 300 by the information acquiring section 113a, it is possible to notify the user of the occurrence of the error using the toast notification function of the OS.

When a predetermined operation is performed with respect to the toast notification indicating the occurrence of the error, the processor 110 displays a detail screen indicating details of the error by the function of the detailed information displaying section 113c. The details of the error include contents based on the second information that cannot be acquired by the general-purpose printer driver 112. With this configuration, according to this embodiment, it is possible to guide the user to detailed information regarding the error that has occurred, a method of coping with the error, and the like.

### 1-2. State Monitoring Process after Print Data Transmission

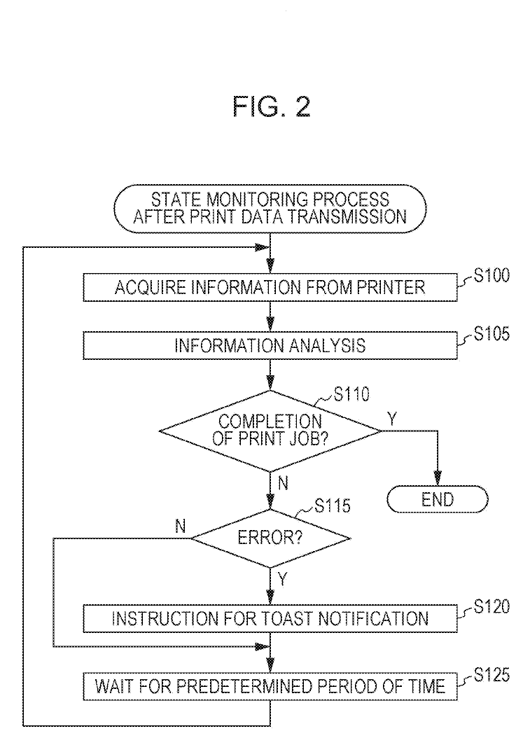

FIG. 2 is a flowchart illustrating a state monitoring process after the print data is transmitted. The state monitoring process after the print data transmission is started after the processor 110 transmits print data D1 of a first page included in a print job to the printer 300. When the process in FIG. 2 is started, the processor 110 acquires information from the printer 300 by a function of the information acquiring section 113a (step S100). That is, the processor 110 acquires information indicating a state of the print job and information indicating a state of the printer 300 from the printer 300.

Subsequently, the processor 110 analyzes the information acquired in step S100 by the function of the information acquiring section 113a (step S105). That is, the processor 110 analyzes the above-described information indicating the state of the print job or the information indicating the state of the printer 300 and specifies contents. The information indicating the state of the print job includes, for example, a file name, the total number of pages, and information indicating whether printing of the print job has been completed. The processor 110 specifies these contents. The information indicating the state of the printer 300 includes, for example, information indicating the number of remaining printing media, the presence or absence of a printing medium jam, amounts of remaining inks, a cover opening/closing state, and the like. The processor 110 specifies these contents.

Subsequently, the processor 110 determines whether the printing of the print job is completed. That is, the processor 110 determines whether the information obtained as a result of step S105 indicates that the printing of the print job is completed. When it is determined in step S110 that the process has been completed, the processor 110 terminates the process of FIG. 2.

When it is not determined that the process is completed in step S110, the processor 110 determines whether an error has occurred by a function of the notification instructing section 113b (step S115). That is, the processor 110 determines whether the information obtained as a result of step S105 indicates that an error has occurred. For example, it is determined whether the printing medium is exhausted, the printing medium is jammed, the ink is exhausted, the cover is opened, or the like.

When it is determined that there is an error in step S115, the processor 110 instructs the toast notification to the OS by the function of the notification instructing section 113b (step S120). That is, the processor 110 causes the OS to issue a toast notification indicating the occurrence of the error.

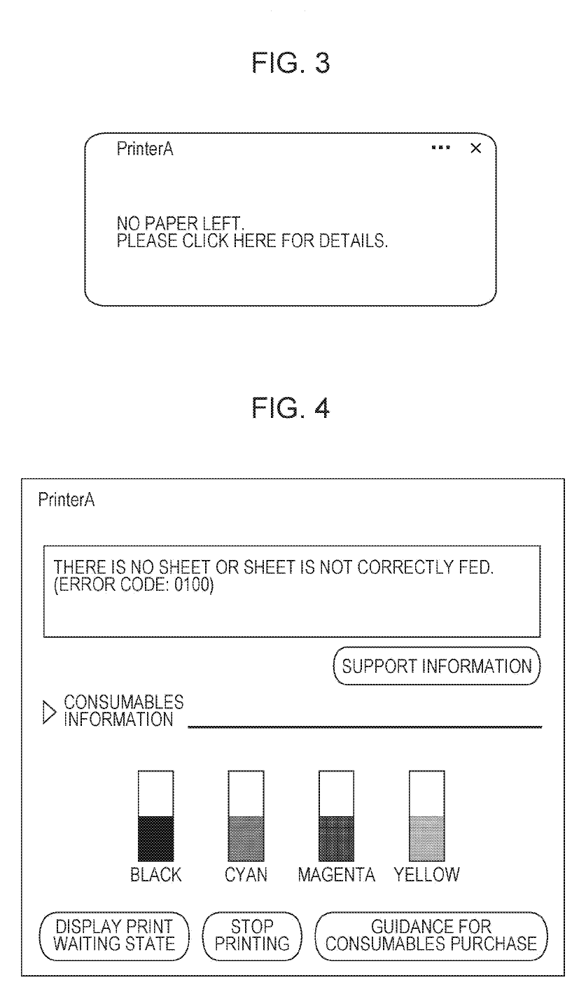

FIG. 3 is a view illustrating a display example of the toast notification indicating the occurrence of the error. In the example illustrated in FIG. 3, the user is notified that the printing medium has run out, and guidance for displaying the detail screen is displayed. The toast notification includes a "close" button for terminating the display, and the user can terminate the display of the toast notification by clicking the "close" button.

When it is not determined that an error has occurred in step S115, or when step S120 is executed, the processor 110 waits for a predetermined period of time (step S125), and performs the process of step S100 and the subsequent steps again after the predetermined period of time elapses.

Note that, when it is detected that the user performs a predetermined operation, such as a click, with respect to the toast notification for notifying the error illustrated in FIG. 3, the processor 110 displays the detail screen for notifying the details of the error by the function of the detailed information displaying section 113c. FIG. 4 is a diagram illustrating an example of the detail screen. On the detail screen, for example, details of the error and a method of coping with the error are displayed. Alternatively, the detail screen may include a button for guiding the user to a web site of a printer vendor on which a method of coping with the error is published. Furthermore, various types of information indicating a state of the printer 300 may be included in the detail screen regardless of the presence or absence of the relationship with the error that has occurred. For example, the example of FIG. 4 indicates that remaining amounts of inks are notified.

### 2. Second Embodiment

The second embodiment is configured to notify the user of progress of generation of the print data D1 in a form of a toast notification. Furthermore, when an error of the printer 300 is detected in a process of monitoring the progress of the generation of the print data D1, a toast notification indicating the occurrence of the error is performed.

The print data generating section 113d causes the processor 110 to implement the function of generating the print data D1 for causing the printer 300 to perform printing based on the print target data 121. To be specific, when the user opens a file indicating the print target data 121 using the application 111 and instructs the printer 300 to execute printing from a menu of the application 111, the processor 110 converts the print target data 121 indicated by the file opened using the application 111 into the print data D1 in a format suitable for printing using the printer 300. The processor 110 transmits the print data D1 thus generated to the printer 300. Note that a portion of the process of generating the print data D1 from the print target data 121 and transmitting the print data D1 to the printer 300 may be executed by the general-purpose printer driver 112.

By the function of the information acquiring section 113a, the processor 110 acquires information indicating the progress of the generation of the print data D1 by the print data generating section 113d. By the function of the notification instructing section 113b, the processor 110 performs the toast notification indicating the progress based on the information indicating the progress. For example, the processor 110 acquires the number of pages for which the generation of the print data is completed in one print job as the information indicating the progress. Then, by the notification instructing section 113b, the processor 110 causes the OS to execute the toast notification indicating the progress based on the information indicating the progress. With this configuration, the processor 110 can cause the user to easily recognize the progress of the print data generation by the toast notification which is automatically displayed.

The processor 110 periodically acquires the information indicating the progress by the function of the information acquiring section 113a. The processor 110 periodically updates the toast notification indicating the progress based on the information indicating the progress by the function of the notification instructing section 113b. With this configuration, the processor 110 can cause the user to recognize the latest progress every time a predetermined period of time elapses.

When it is determined that the printing of the print job is completed based on the information acquired from the printer 300 by the information acquiring section 113a, the processor 110 terminates the toast notification by the function of the notification instructing section 113b. With this configuration, it is possible to prevent the display of the toast notification from being continued even after the printing is completed.

### 2-1. Progress Monitoring Process of Printing

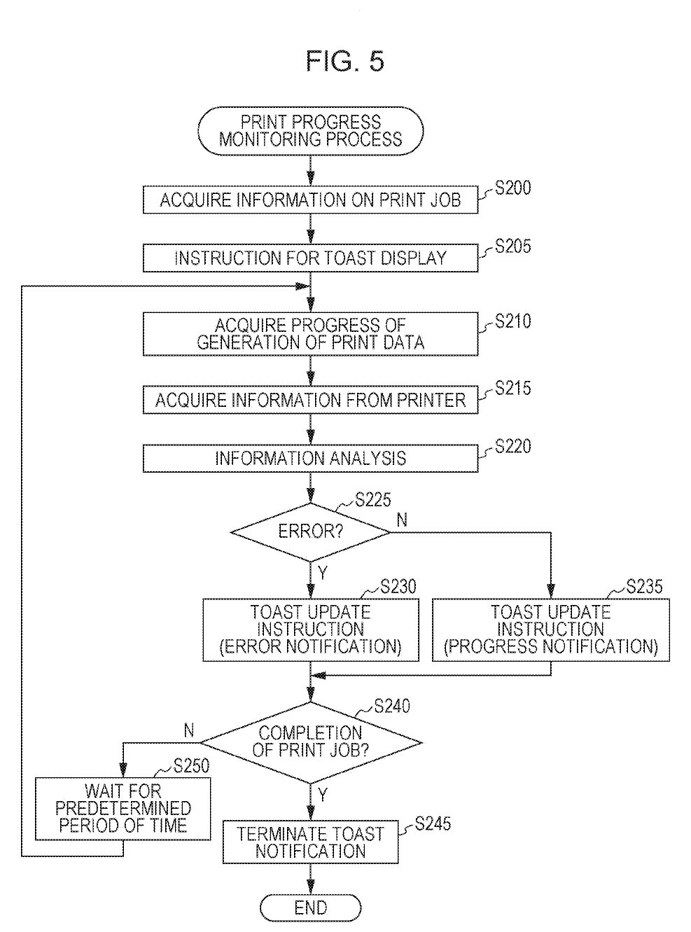

FIG. 5 is a flowchart illustrating the print progress monitoring process performed by the auxiliary app 113. The process illustrated in FIG. 5 is started when an instruction to print the print target data 121 by the printer 300 is received from the user. In the process illustrated in FIG. 5, the progress of the generation of the print data D1 and the state of the printer 300 are periodically monitored at predetermined time intervals.

When the print progress monitoring process is started, the processor 110 acquires information on a print job using the information acquiring section 113a (step S200). That is, the processor 110 acquires information on a print job from the print data generating section 113d. The processor 110 refers to the information on the print job being processed by the print data generating section 113d and acquires the information by the information acquiring section 113a. Specifically, for example, the information on the print job includes a file name of the print target data 121, the number of pages to be printed, and the like.

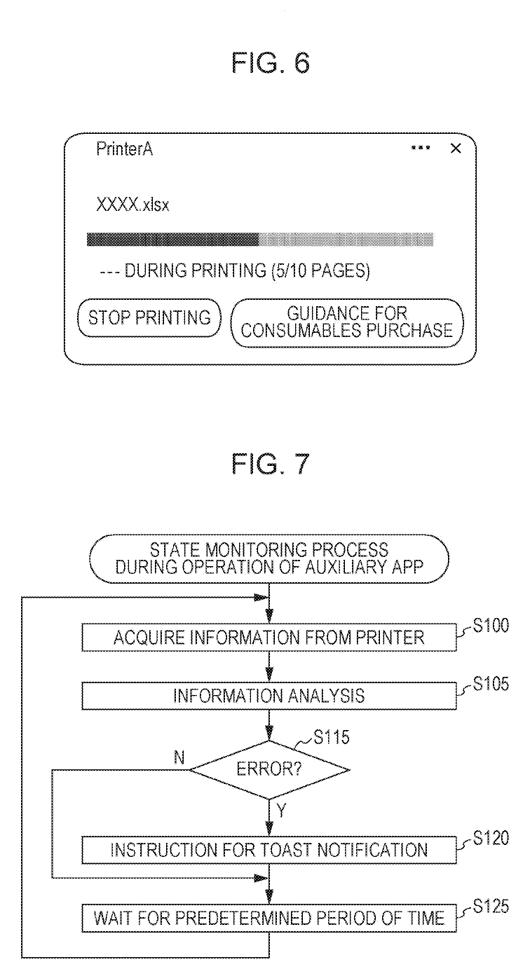

Subsequently, the processor 110 instructs the OS to perform the toast notification by the function of the notification instructing section 113b (step S205). That is, the processor 110 causes the OS to display a toast notification indicating progress (initial state) of printing. FIG. 6 is a view illustrating an example of the toast notification indicating progress of printing. The toast notification indicating the progress includes a printer name, a file name of the print target data 121, a progress bar indicating the progress, a page number of print data being generated (or a page number of print data that has been generated), and the number of pages to be printed. The toast notification indicating the progress may include a print cancel button, a button for guiding to a consumable purchase site, and the like. Although FIG. 6 illustrates an example in which generation of five pages out of ten pages of the print data has been completed, when generation of even one page has not been completed at the time of execution of step S205, a progress bar indicating that, for example, the progress is zero pages out of ten pages is displayed.

Subsequently, the processor 110 acquires the progress of the generation of the print data D1 by the function of the information acquiring section 113a (step S210). That is, the processor 110 acquires information indicating a page number of a page which is being generated by the print data generating section 113d, a page number of a page which has been generated, and the like by the information acquiring section 113a with reference to the data in the processing performed by the print data generating section 113d.

Subsequently, the processor 110 acquires information from the printer 300 by the function of the information acquiring section 113a (step S215), and analyzes the acquired information (step S220). The processes in step S215 and step S220 are the same as the processes in step S100 and step S105 in FIG. 2.

Subsequently, the processor 110 determines whether an error has occurred using the function of the notification instructing section 113b (step S225). That is, the processor 110 determines whether the information obtained in step S220 indicates that an error has occurred in the printer 300.

When it is not determined that an error has occurred in step S225, the processor 110 issues a toast update instruction to the OS by the function of the notification instructing section 113b (step S235). That is, the processor 110 updates a length of the progress bar in accordance with the page number illustrated in FIG. 6 or a ratio of the page number to the total number of pages to be printed based on the information acquired from the print data generating section 113d in step S210.

When it is determined in step S225 that an error has occurred, the processor 110 issues a toast update instruction to the OS by the function of the notification instructing section 113b (step S230). That is, the processor 110 instructs the OS to update content of the toast notification to content indicating that the error has occurred. The toast notification indicating that the error has occurred is displayed, for example, in the form illustrated in FIG. 3.

After performing step S230 or step S235, the processor 110 determines whether the print job is completed (step S240). That is, the processor 110 determines whether the information obtained in step S220 indicates completion of the print job. When it is determined in step S240 that the print job has been completed, the processor 110 instructs the OS to terminate the toast notification (step S245). As a result, the display of the toast notification is terminated.

When it is not determined that the print job is completed in step S240, the processor 110 waits for a predetermined period of time (step S250) and returns to the process of step S210. That is, the process from step S210 to step S240 is executed at regular time intervals. Therefore, when an error has not occurred in the printer 300, the toast notification indicating the progress of step S235 is periodically updated.

### 3. Other Embodiments

The above embodiments are examples for embodying the present disclosure, and various other embodiments may be adopted. For example, the information processing apparatus may be in a form of a tablet or a smartphone other than a PC. The OS of the information processing apparatus is not limited to the OS for a PC.

The printer may be an apparatus having a communication function and a printing function, but may be a multifunction peripheral having other functions, such as a scanner function, a copy function, and a facsimile function.

The form of the notification based on the first information and the second information may differ depending on a type or a version of the OS. Furthermore, the notification is not limited to a notification named "toast notification".

In the above-described embodiment, the configuration in which the detail screen indicating details of an error is displayed when a predetermined operation is performed on the toast notification indicating occurrence of the error is exemplified. However, at least a portion of information indicating details of an error may be displayed on the toast notification indicating occurrence of the error. For example, when a printing medium jam has occurred, the toast notification may include information indicating a location of the printing medium jam. Then, a method for coping with the jam may be displayed on the detail screen.

Note that a timing at which the state of the printer 300 is monitored is not limited to a timing after the printer 300 starts printing or a timing after the generation of the print data D1 is started as illustrated in FIGS. 2 and 5. The state of the printer 300 may be monitored when the auxiliary app 113 is in the activated state regardless of whether the print data D1 is being generated or whether printing based on the print data D1 is being executed. In addition, in a state in which the auxiliary app 113 is operated, when the user instructs start of the monitoring of a state of the printer 300, the monitoring of a state of the printer 300 may be constantly performed.

FIG. 7 is a flowchart illustrating the state monitoring process performed during operation of the auxiliary app 113. The process illustrated in FIG. 7 is started, for example, when the auxiliary app 113 is selected from an application list of the information processing apparatus 100. The process illustrated in FIG. 7 is a process in which step S110 is deleted from the process illustrated in FIG. 2. That is, in the state in which the auxiliary app 113 is operated, the processor 110 repeatedly executes the process from step S100 to step S120 every time a predetermined period of time elapses. When occurrence of an error is detected based on the information acquired from the printer 300, as illustrated in step S120, the processor 110 causes the OS to perform the toast notification for notifying the error.

Note that the process illustrated in FIG. 7 terminates when the auxiliary app 113 terminates. When the toast notification is being displayed, the processor 110 also terminates the display of the toast notification along with the termination of the auxiliary app 113.

In the above-described embodiment, the information acquiring section is configured to acquire and notify progress of generation of print data as progress of printing. However, the information acquiring section may be configured to update the progress of printing in the printer based on information acquired from the printer. For example, a configuration may be adopted in which the number of pages (or a page number) for which printing has been completed is acquired from the printer, and a notification of information indicating the progress of printing is performed based on this information.

Furthermore, the present disclosure may be applied to a program executed by a computer and to a notification method. In addition, a system, a program, and a method as described above may be implemented as a single device or by using components included in a plurality of devices, and various implementation forms are encompassed. In addition, the configuration may be appropriately changed, for example, in such a manner that a portion of the configuration is software and a portion of the configuration is hardware. Furthermore, the present disclosure may also be implemented as a recording medium that stores a program for controlling the system. The recording medium for the program may, of course, be a magnetic recording medium or a semiconductor memory, and any recording medium to be developed in the future may be considered in the same manner.

What is claimed is:

1. A non-transitory computer-readable storage medium storing a print control program, the print control program causing a computer to function as:
an information acquiring section that acquires both first information and second information relating to printing by a printer; and
a notification instructing section that causes an OS to perform a notification based on the first information and the second information, wherein
the first information is obtainable by not only a general-purpose printer driver but also the information acquiring section, and
the second information is not obtainable by the general-purpose printer driver but is obtainable by the information acquiring section.

2. The non-transitory computer-readable storage medium storing the print control program according to claim 1, wherein the print control program is a print support application.

3. The non-transitory computer-readable storage medium storing the print control program according to claim 1, wherein
when the first information or the second information includes information indicating an error that has occurred in the printer,
the notification instructing section causes the OS to perform a toast notification indicating the occurrence of the error.

4. The non-transitory computer-readable storage medium storing the print control program according to claim 3, the print control program causing the computer to further function as:
a detailed information displaying section that displays a detail screen indicating a detail of the error when a predetermined operation is performed on the toast notification.

5. The non-transitory computer-readable storage medium storing the print control program according to claim 1, wherein
the information acquiring section acquires information indicating progress of generation of print data for causing the printer to perform printing based on print target data, and
the notification instructing section causes the OS to perform a toast notification indicating the progress based on the information indicating the progress.

6. The non-transitory computer-readable storage medium storing the print control program according to claim 5, wherein
the information acquiring section periodically acquires the information indicating the progress, and
the notification instructing section periodically updates the toast notification indicating the progress based on the information indicating the progress.

7. The non-transitory computer-readable storage medium storing the print control program according to claim 6, wherein
the notification instructing section terminates the toast notification indicating the progress when it is determined that printing of a print job is completed based on the information acquired from the printer by the information acquiring section.

8. An information processing apparatus, comprising:
an information acquiring section that acquires both first information and second information relating to printing by a printer; and
a notification instructing section that causes an OS to perform a notification based on the first information and the second information, wherein
the first information is obtainable by not only a general-purpose printer driver but also the information acquiring section, and
the second information is not obtainable by the general-purpose printer driver but is obtainable by the information acquiring section.

9. A notification method, comprising:
acquiring, by an information acquiring section, both first information and second information relating to printing by a printer; and
causing, by a notification instructing section, an OS to perform a notification based on the first information and the second information, wherein
the first information is obtainable by not only a general-purpose printer driver but also the information acquiring section, and
the second information is not obtainable by the general-purpose printer driver but is obtainable by the information acquiring section.
